(19) United States
(12) Patent Application Publication
(10) Pub. No.: US 2007/0067490 A1
(43) Pub. Date: Mar. 22, 2007

(54) Method and device for handling modifications of network addresses during mobile data transmission

(76) Inventors: Jochen Grimminger, Munchin (DE); Mirko Naumann, Gerestsried (DE); Michael Schielein, Munchin (DE)

Correspondence Address: STAAS & HALSEY LLP, SUITE 700, 1201 NEW YORK AVENUE, N.W., WASHINGTON, DC, 20005, US

(21) Appl. No.: 10/570,671

(22) PCT Filed: May 13, 2004
(86) PCT No.: PCT/EP04/50781

§ 371 Date: Mar. 6, 2006

(30) Foreign Application Priority Data
Sep. 4, 2003 (DE) 103 40 805.3

(51) Int. Cl. G06F 15/16

(52) U.S. Cl. 709/245

(57) ABSTRACT

When mobile data transmission occurs in a data network, a modification of an IP address in a lower protocol layer which, for example, uses the DCCP protocol supporting modification of the IP address in an existing data link, is indicated in relation to a higher protocol layer such that links existing in the higher protocol layer can be updated with the IP address. The higher protocol layer can include the SIP signaling protocol during a Voice-over-IP-voice communication application, for example, in addition to a real time data transmission protocol. Said SIP signaling protocol can update URI identifier and IP address assignment information when the address is modified.

### CROSS REFERENCE TO RELATED APPLICATIONS

This application is based on and hereby claims priority to PCT Application No. PCT/EP2004/050781 filed on May 13, 2004 and German Application No. 10340805.3 filed on Sep. 4, 2003, the contents of which are hereby incorporated by reference.

### BACKGROUND OF THE INVENTION

The invention relates to a method and a correspondingly configured device for data transmission in a data network, particularly for mobile data transmission corresponding to the Internet protocol (IP) in a radio-based cellular data network, e.g. as part of a Voice-over-IP application.

To connect mobile data transmission devices to data networks, radio-based cellular data networks into which the mobile user dials are normally used. The Internet protocol is normally used for data transmission. When dialing into the data network, the data transmission device is assigned an address, especially an IP address, by which the data transmission device in the data network can be identified, by a network operator. For certain applications, e.g. for voice communication using a Voice-over-IP application, there are links to the IP address in higher protocol layers that are required, for example, to route the data to the correct receiver or to identify the sender of the data.

Voice-over-IP applications use, typically in a higher protocol layer, a realtime data transmission protocol, such as the RTP (Realtime Transport Protocol) and, in a protocol layer below this, a transport protocol, such as the DCCP (Datagram Congestion Protocol). The DCCP protocol offers particular advantages when transmitting digital voice and image data between two communication partners and particularly provides a simple means for supporting mobile applications, in that, for example, it enables the IP address to be modified during an existing data connection.

To set up and control data connections, signaling protocols are used for voice communication applications in a higher protocol layer, which is situated above the protocol layer of the transport protocols. The signaling protocol layer SIP (Session Initiation Protocol) includes, for example, URI identifiers (Uniform Resource Identifier). A user of a Voice-over-IP voice communication application receives a globally valid identification by such a URI identifier. A URI identifier is in this case assigned a specific IP address so that data meant for a user identified by a specific URI identifier can be sent to the relevant IP address. The assignment information of the URI identifier and IP address are centrally administered in the data network.

If the mobile data transmission device moves within a cellular data network, this can cause a cell of the data network in which the mobile data transmission device is presently located to change. It is also possible that the mobile data transmission device moves into a cell of a further radio-based cellular data network that is connected to the first cellular data network via a higher-level data network. If the other cellular data network is operated by a different network operator, a change of network operator can occur. In the case of the aforementioned processes, the mobile user is usually assigned a new IP address. Because the assignment of the URI identifier and IP address is now false, an existing data connection controlled by the SIP protocol, e.g. a realtime transmission of voice as part of a Voice-over-IP application, can no longer be maintained.

There is thus a problem during data transmission in that if during an existing data connection controlled by a higher protocol layer the IP address of a data transmission device changes, the link to the IP address at the level of this higher protocol layer is then no longer current. This problem exists particularly in the case of a mobile data transmission device that moves into a different cell of the cellular data network, while a data connection exists that is controlled through the SIP signaling protocol.

In order, nevertheless, to enable mobility within an IP data network, the MIP protocol (Mobile Internet Protocol) was specified, that assigns a permanent IP address to a mobile data transmission device, that remains valid regardless of the particular location of the mobile data transmission device. Because this IP address is assigned to a specific area of the data network but the mobile data transmission device can in fact be in a different, far removed, area of the data network, MIP requires comprehensive diversions of the data traffic, with associated delays, and is associated with higher overall costs. Also, MIP is suitable for realtime data transmission only in a special, faster configuration, called FastMIP.

### SUMMARY OF THE INVENTION

One possible object of this invention is therefore to provide a method and a device for data transmission that solves the problem, described above, of changes in the address and thus enables the features and advantages of protocols matched to special applications to be utilized at low cost.

The inventors propose that in the event of a change of an address by which a data transmission device at the level of a lower protocol layer can be identified, this change is indicated to a higher protocol layer, so that at the level of the third protocol layer existing links with the address can be updated.

The change of the address can, e.g. in the form of an IP address, in this case, depending on the particular system environment, be indicated by the triggering of an interrupt, the callup of a callback function or the transmission of a message in the form of a message object. Preferably in this case the new address is transmitted to the higher protocol layer so that this information can be used with the address when updating the links existing at the level of the higher protocol layer.

The method and devise are particularly suitable for mobile data transmission in a cellular data network corresponding to the IP protocol, as part of a voice data connection that is controlled at the level of a higher protocol layer by a signaling protocol such as the SIP protocol. In this case, the voice data connection advantageously includes a realtime data transmission protocol, such as the RTP protocol, and a transport protocol such as the DCCP protocol.

This provides the advantage that the features of the DCCP protocol, tailored to multimedia applications, are available in conjunction with the SIP protocol during mobile data transmission. In particular, the mobility concepts contained in the DCCP protocol, i.e. a change in the IP address during an existing data connection, can be included in the data transmission by using the SIP signaling protocol. In this way, the realtime transmission of data, e.g. voice data in a Voice-over-IP application, can be advantageously achieved in a mobile environment.

Furthermore, because the method and device are based only on the possibility of changing the IP address, there is the advantage that mobile data transmission is based on the DCCP and SIP protocols and therefore compatible with the MIP concept, that provides a permanent IP address.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows in schematic form a cellular data network suitable according to one potential application of the invention, and

FIG. 2 shows a block diagram for illustrating a method of data transmission in accordance with a preferred exemplary embodiment of this invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

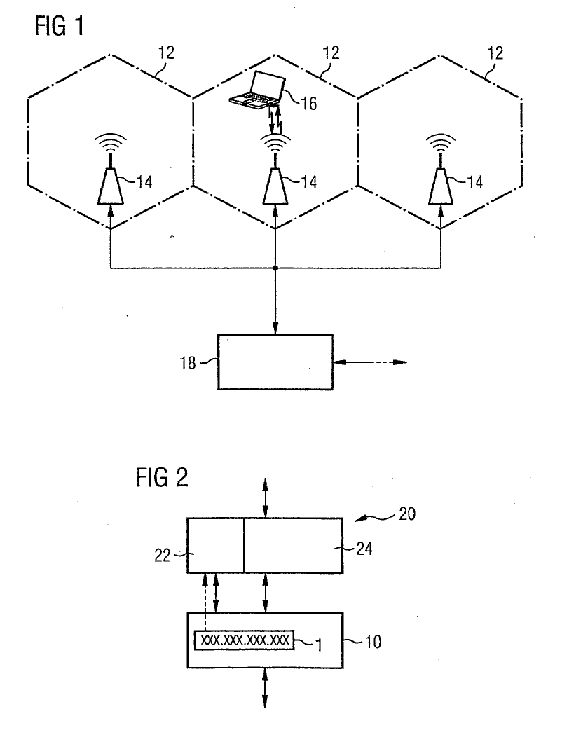

FIG. 1 is a schematic of a radio-based cellular data network. Radio stations or base stations 14 enable a data connection of a mobile data transmission device 16. The radio-based cellular data network has a switching device 18 that controls the data traffic from and to the radio stations 14 and undertakes administration functions of the radio-based cellular data network. The switching device 18 thus particularly also controls the data traffic with the mobile data transmission device 16 in the cellular data network. Through the switching device 18, the radio-based cellular data network can have a data connection to other parts of a higher-level data network that includes the radio-based cellular data network as a part. The mobile data transmission device 16 can thus, via the radio-based cellular data network, maintain a data connection to other mobile data transmission devices 16 in the same cellular network, to other mobile data transmission devices in other, also radio-based, cellular parts of the higher-level data network or to non-mobile data transmission devices in other parts of the higher-level data network, for example in a fixed network.

For data transmission via the radio-based cellular data network corresponding to the IP protocol, a radio connection is set up between the radio station 14 that supplies the cell 12 of the cellular data network in which the mobile data transmission device 16 is presently located and the data transmission device itself. In doing so, the mobile data transmission device 16 is assigned an IP address 1. If the mobile data transmission device 16 moves to a different cell 12 of the data network, the new radio connection to the corresponding radio station 14 is established. A new IP address 1 is then also assigned to the mobile data transmission device 16.

FIG. 2 illustrates, as an exemplary embodiment of this invention, a method for data transmission where voice data is transmitted as part of a Voice-over-IP application. For data transmission, the method uses the IP protocol that has a lower protocol layer 10 and a higher protocol layer 20 above it. The lower protocol layer 10 uses the DCCP transport protocol that is especially suited to multimedia applications. This also supports a change in the IP address during an existing data connection, i.e. the assignment of a new IP address 1 in the radio-based cellular data network can be processed by the DCCP protocol. The method uses, in the higher protocol layer, the SIP signaling protocol 22 that undertakes control functions of a voice data connection for the transmission of voice data. Furthermore, for the voice data connection in the higher protocol layer, the method uses the RTP realtime data transmission protocol 24 in addition to the SIP signaling protocol 22.

In accordance with the SIP protocol, for example with a Voice-over-IP telecommunication application, a user is reached via a globally valid URI identifier. Because the identification of a mobile data transmission device 16 via the IP address 1 takes place in the lower protocol layer 10, information regarding the assignment of the URI identifier and IP address 1 is required at the level of the SIP signaling protocol 22, i.e. in the higher protocol layer 20. This assignment information can be centrally administered, e.g. on a server such as the switching device 18 shown in FIG. 1.

If there is a change in the IP address 1, e.g. because the mobile data transmission device 16 shown in FIG. 1 moves to a different cell 12 of the radio-based cellular data network, this is indicated to the higher protocol layer 20. This can take place by the communication of information, particularly in that the new IP address 1 is available at the level of the SIP signaling protocol 22. This information is used at the level of the SIP signaling protocol 22 to update existing links with the IP address. In particular, the assignment information of the URI identifier and IP address administered on the server can be updated so that continuation of the voice connection is guaranteed. In the example of an embodiment shown, the mobile data transmission device 16 is configured in such a way that a change in its IP address 1 is indicated to the higher protocol layer 20. This takes place by the transmission of a message in the form of a message object, that contains the new address as information. Callback functions, interrupts etc can also be used, depending on the system environment, to indicate the change of address.

The explained exemplary embodiments describe the transmission of voice data as part of a mobile Voice-over-IP application in a radio-based cellular IP data network. The invention is, however, not limited to this. A further advantageous possible application is, for example, the mobile realtime transmission of multimedia data in a radio-based cellular data network.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

Claims

1

-

15

. (canceled)

16. A method of data transmission in a data network using a protocol having a lower protocol layer and a higher protocol layer above the lower protocol layer, comprising:
establishing a data connection between at least one data transmission device and the data network, each data transmission device being identifiable by an assigned address at a level of the lower protocol layer, the lower protocol layer being configured to permit a change of the address during an existing data connection;
changing the address at the level of the lower protocol layer to a changed address; and
indicating the change of address to the higher protocol layer, so that the higher protocol layer can update existing links with the address, after the changing.

17. The method of claim 16, wherein, in the indicating, the change of address is indicated by a triggering of an interrupt, a callup of a callback function, or a transmission of a message in the form of a message object.

18. The method of claim 17, further comprising displaying the changed address, wherein, when the changed address is displayed, the changed address is communicated to the higher protocol layer.

19. The method of claim 16, wherein the protocol is an Internet protocol (IP).

20. The method of claim 19, wherein the address is an IP address corresponding to the Internet protocol.

21. The method of claim 19, wherein the lower protocol layer includes a Datagram Congestion Protocol (DCCP) transport protocol.

22. The method of claim 19, wherein the higher protocol layer includes a signaling protocol.

23. The method of claim 22, wherein the signaling protocol is a Session Initiation Protocol (SIP) protocol, and
wherein a user at a data connection to the data network controlled by the SIP protocol is identifiable by a globally valid Uniform Resource Identifier (URI).

24. The method of claim 23, wherein, when there is a change in the address at the level of the SIP protocol, an assignment of the globally valid URI identifier to the address of the at least one data transmission device is updated, and
wherein corresponding assignment information of URI identifiers and IP addresses are centrally administered in the data network.

25. The method of claim 19, wherein a higher protocol layer of the Internet protocol uses a realtime data transmission protocol for the realtime transmission of data.

26. The method of claim 25, wherein the realtime data transmission protocol is a Realtime Data Transmission Protocol (RTP).

27. The method of claim 16, wherein at least a part of the data network is a radio-based cellular data network.

28. The method of claim 25, wherein the realtime transmission of data includes realtime transmission of voice data as part of a mobile Voice-over-IP application.

29. A data network over which data is transmitted using a protocol having a lower protocol layer and a higher protocol layer above the lower layer, comprising:
at least one data transmission device connectable to the data network, each data transmission device being identifiable by an assigned address at a level of the lower protocol layer, the lower protocol layer being configured to permit a change of the address during an existing data connection,
wherein, when the address of one of the at least one data transmission device at the level of the lower protocol layer is changed, the change of address is indicated to the higher protocol layer, so that the higher protocol layer can update existing links with the address.

30. The data transmission device of claim 29, wherein the data transmission device uses the method of claim 16.
